(19) United States
(12) Patent Application Publication
(10) Pub. No.: US 2011/0290086 A1
(43) Pub. Date: Dec. 1, 2011

(54) Socket Wrench

(76) Inventor: SHIH-CHIEH CHIU, Taiping City (TW)

(21) Appl. No.: 12/787,065

(22) Filed: May 25, 2010

(51) Int. Cl. B25B 13/06

(52) U.S. Cl. 81/121.1

(57) ABSTRACT

A socket includes faces, grooves and groups of notches. Each of the grooves is located between two adjacent one of the faces. Each of the grooves includes a width that gets smaller towards an axis of the socket along a radius, thus defining a reduced neck. Each of the groups of notches is located along a related one of the grooves or in a related one of the faces.

### BACKGROUND OF INVENTION

1. Field of Invention

The present invention relates to a socket wrench and, more particularly, to a socket for a socket wrench.

2. Related Prior Art

Referring to FIG. 1, a conventional socket includes a cavity defined therein. The cavity is defined by six planar faces and six concave faces. The planar faces and the concave faces are arranged alternately. The concave faces are intended to protectively receive corners of a nut or a head of a screw. Similar sockets can be found in Taiwanese Patents M265161 and I316011. The total area of contact of the socket with the nut or the head of the screw is however reduced because of the concave faces. Hence, the engagement of the socket with the nut or the head of the screw is jeopardized.

The present invention is therefore intended to obviate or at least alleviate the problems encountered in prior art.

### SUMMARY OF INVENTION

It is the primary objective of the present invention to provide a wrench with a socket for firm and protective engagement with a nut or a head of a screw.

To achieve the foregoing objective, the socket includes faces, grooves and groups of notches. Each of the grooves is located between two adjacent one of the faces. Each of the grooves includes a width that gets smaller towards an axis of the socket along a radius, thus defining a reduced neck. Each of the groups of notches is located along a related one of the grooves or in a related one of the faces.

Other objectives, advantages and features of the present invention will be apparent from the following description referring to the attached drawings.

### BRIEF DESCRIPTION OF DRAWINGS

The present invention will be described via detailed illustration of five embodiments versus the prior art referring to the drawings wherein:

FIG. 1 is a top view of a conventional socket;

FIG. 2 is a cut-away view of a socket according to the first embodiment of the present invention;

FIG. 3 is a top view of the socket shown in FIG. 2;

FIG. 4 is a cross-sectional view of the socket shown in FIG. 2;

FIG. 5 is a cross-sectional view of a socket according to the second embodiment of the present invention;

FIG. 6 is a cross-sectional view of a socket according to the third embodiment of the present invention;

FIG. 7 is a cross-sectional view of a socket according to the fourth embodiment of the present invention; and

FIG. 8 is a top view of a socket according to the fifth embodiment of the present invention.

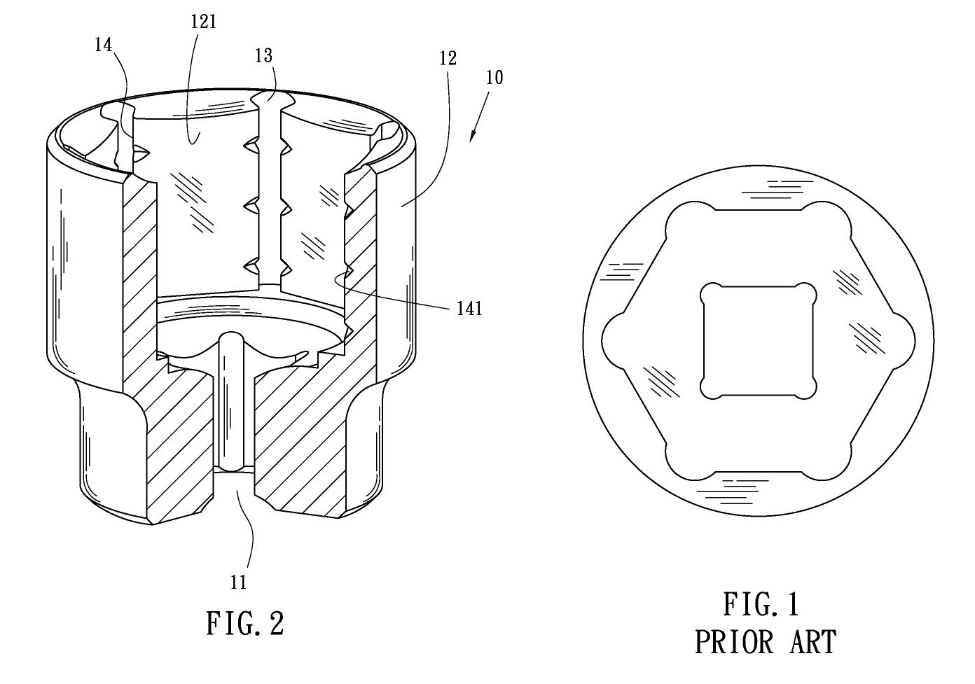

### DETAILED DESCRIPTION OF EMBODIMENTS

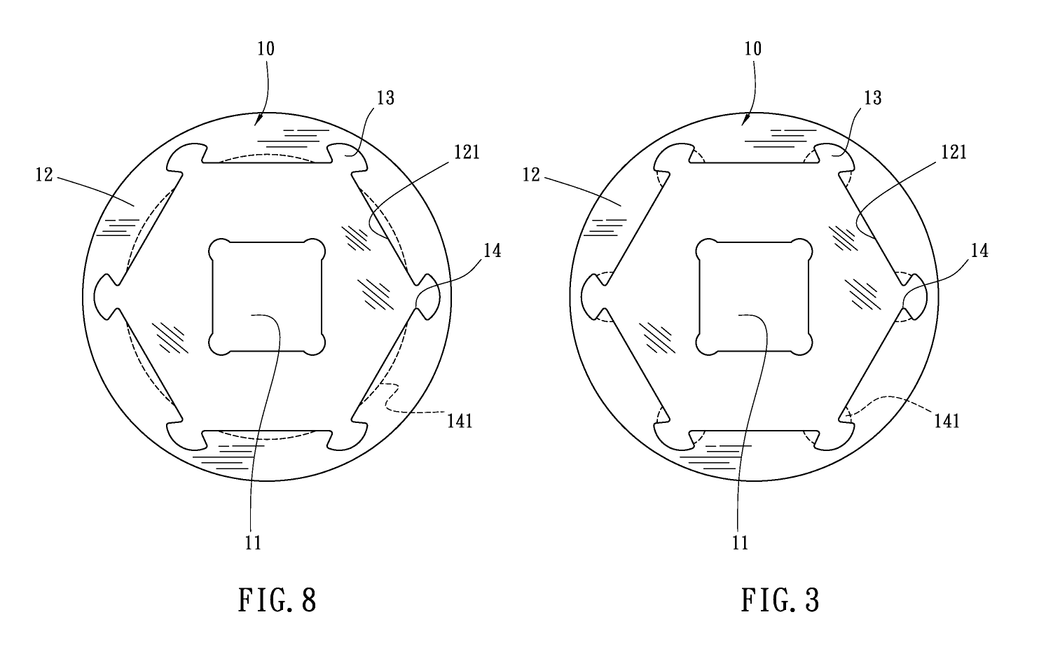

Referring to FIGS. 2 and 3, there is shown a socket 10 according to a first embodiment of the present invention. The socket 10 includes a first cavity defined in a first end 11 and a second cavity defined in a second end 12. The first cavity is preferably square when it is viewed along an axis of the socket 10. The first cavity is intended to receive a preferably square insert of a handle of a socket wrench. The second cavity is preferably hexagonal when it is viewed along the axis of the socket 10. The second cavity is intended to receive a preferably hexagonal nut or a preferably hexagonal head of a screw.

The second cavity of the socket 10 is defined by a wall. The wall of the second cavity of the socket 10 includes preferably six planar faces 121 and six grooves 13. Each of the grooves 13 is located between two related ones of the planar faces 121. The wall of the second cavity of the socket 10 can however include four or twelve planar faces 121 and grooves 13 in another embodiment.

Each of the grooves 13 includes a width that gets smaller towards the axis along a radius. Thus, each of the grooves 13 includes a reduced neck 14. The reduced neck 14 enable the grooves 13 to protectively receive corners of the nut or the head of the screw without reducing the total area of contact of the planar faces 121 with the faces of the nut or the head of the screw.

Moreover, there are six groups of notches 141 defined in the wall of the second cavity of the socket 10. Each of the groups of notches 141 is located along a related one of the grooves 13.

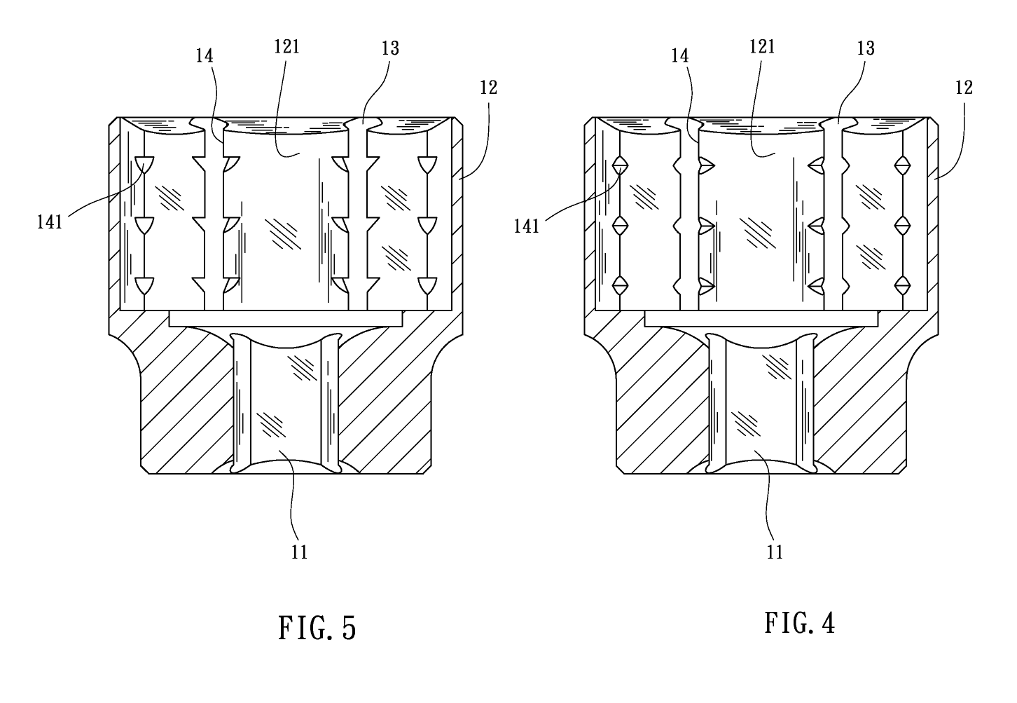

Referring to FIG. 4, each of the notches 141 is V-shaped. That is, each of the notches 141 is defined by two planar facets inclined relative to the axis of the socket 10.

Referring to FIG. 5, there is shown a socket according to a second embodiment of the present invention. The second embodiment is like the first embodiment except that each of the notches 141 is defined by a planar facet in perpendicular to the axis of the socket 10 and another planar facet inclined relative to the axis of the socket 10.

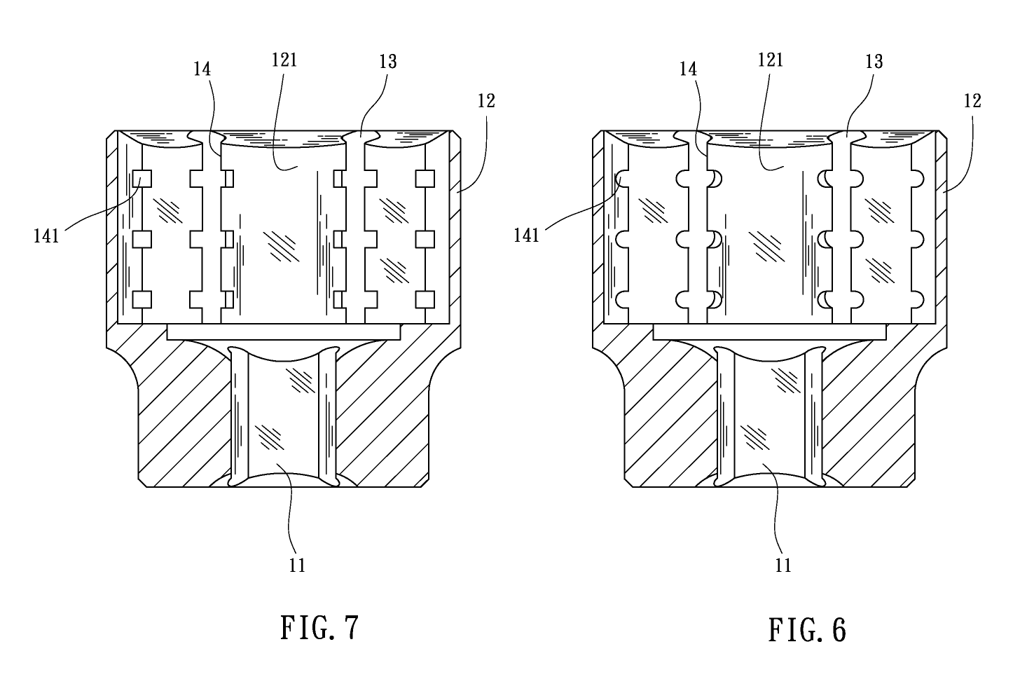

Referring to FIG. 6, there is shown a socket according to a third embodiment of the present invention. The third embodiment is like the first embodiment except that each of the notches 141 is square in stead of V-shaped. That is, each of the notches 141 is defined by two planar facets in perpendicular to the axis of the socket 10 and another planar facet in parallel to the axis of the socket 10.

Referring to FIG. 7, there is shown a socket according to a fourth embodiment of the present invention. The fourth embodiment is like the first embodiment except that each of the notches 141 is defined by two planar facets in perpendicular to the axis of the socket 10 and a concave facet between the planar facets.

Referring to FIG. 8, there is shown a socket according to a fifth embodiment of the present invention. The fifth embodiment is like the first embodiment except that each of the grooves of notches 141 is located in a related one of the faces 121 instead of along any of the grooves 13.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A socket including:
faces;
grooves defined therein so that each of the grooves is located between two adjacent one of the faces, wherein each of the grooves includes a width that gets smaller towards an axis of the socket along a radius, thus defining a reduced neck; and
groups of notches defined therein, wherein each of the groups of notches is located along a related one of the grooves.

2. The socket according to claim 1, wherein each of the notches is defined by two planar facets inclined relative to the axis of the socket.

3. The socket according to claim 1, wherein each of the notches is defined by a planar facet in perpendicular to the axis of the socket and another planar facet inclined relative to the axis of the socket.

4. The socket according to claim 1, wherein each of the notches is defined by two planar facets in perpendicular to the axis of the socket and another planar facet in parallel to the axis of the socket.

5. The socket according to claim 1, wherein each of the notches is defined by two planar facets in perpendicular to the axis of the socket and a concave facet between the planar facets.

6. The socket according to claim 1, wherein the faces are planar.

7. A socket including:
faces;
grooves defined therein, wherein each of the grooves is located between two adjacent ones of the faces, wherein each of the grooves includes a width that gets smaller towards an axis of the socket along a radius, thus defining a reduced neck; and
groups of notches defined therein, wherein each of the groups of notches is located in a related one of the faces.

8. The socket according to claim 7, wherein the faces are planar.
